(19) United States
(12) Patent Application Publication
(10) Pub. No.: US 2004/0108772 A1
(43) Pub. Date: Jun. 10, 2004

(54) Snowmobile track lug stud

(76) Inventors: Ralph G. Pribyl, Maple Lake, MN (US); Wayne E. Scholl, Little Falls, MN (US)

Correspondence Address: Nickolas E. Westman, WESTMAN CHAMPLIN & KELLY, Suite 1600 - International Centre, 900 South Second Avenue, Minneapolis, MN, 55402-3319, US

(21) Appl. No.: 10/104,152

(22) Filed: Mar. 22, 2002

Related U.S. Application Data
(60) Provisional application No. 60/334,313, filed on Nov. 30, 2001.

(51) Int. Cl. B62D 55/24

(52) U.S. Cl. 305/178

(57) ABSTRACT

A screw-in stud has a self-tapping thread on a shank, and a head portion that has a cone shaped protrusion that will extend outwardly from a lug of an off road tire or a snowmobile track in which the screw is threaded. The cone shaped protrusion has a carbide pin at the outer end that is sharpened for increasing traction.

The present application is based on and claims the benefit of U.S. provisional patent application Serial No. 60/334,313, filed Nov. 30, 2001, the content of which is hereby incorporated by reference in its entirety.

### BACKGROUND OF THE INVENTION

Snowmobiles, ATV's, motorcycles and many other vehicles that are driven over ice, or other hard and slippery surfaces utilize an endless track or tires that have raised lugs. The present invention relates to the use of a screw that has a point protruding from its head and which is threaded into the lug of a vehicle tire or drive track to increase the penetration into hard surfaces such as ice.

In the prior art, various types of track studs for snowmobile tracks and tires have been advanced, and also other types of screw-in studs have been used at the ends of track lugs. However, it is desirable to keep the cost of the screw-in studs down, and thus advances in simple designs that provide adequate penetration, wearability and thus improved traction are desired.

### SUMMARY OF THE INVENTION

The present invention relates to a traction improving stud that comprises a screw that can be threaded directly into a protruding lug on a vehicle drive member, such as a lug on an endless drive track or belt for a snowmobile or a lug on a tire, and which has a cone shaped protrusion or stud head that is sharpened to form a point that penetrates ice and frozen ground easily. The screw-in stud is made with a self-tapping end and thread so that it can be driven directly into a synthetic material lug, such as rubber or other elastomeric materials from which the off road tires and tracks are made.

The stud can be driven in easily with a power driver, and thus can also be replaced easily if the penetrating point wears or becomes unusable.

### BRIEF DESCRIPTION OF THE DRAWINGS

FIG. 1 is a schematic fragmentary perspective view of a typical snowmobile track lug showing a stud made according to the present invention in an exploded position above the lug;

FIG. 2 is a schematic cross-sectional view of a track lug having a threaded in screw stud made according to the present invention installed thereon;

FIG. 3 is a top plan view of FIG. 2; and

FIG. 4 is a side view of the screw stud of FIG. 2 removed from the lug and with the cone shaped penetrating stud point in cross section.

### DETAILED DESCRIPTION OF THE PREFERRED EMBODIMENTS

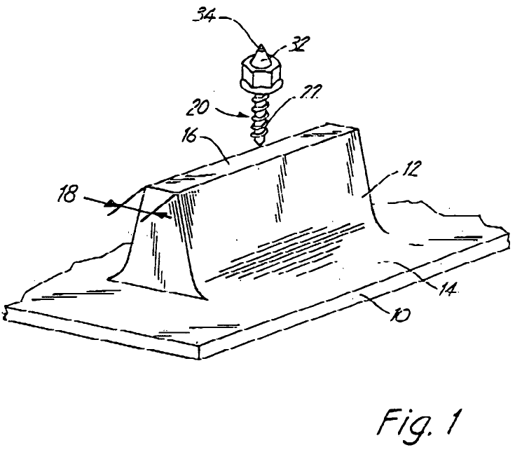

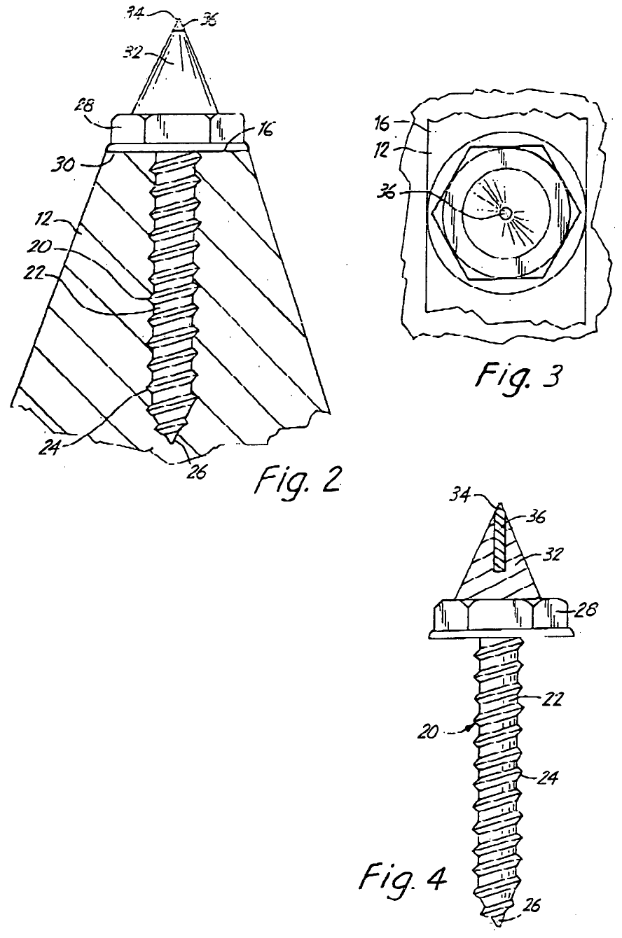

Referring to FIG. 1, a drive member such as a snowmobile track or an off road tire 10 is of conventional design and is made of a flexible material, such as reinforced (steel belted) rubber, a reinforced elastomer, or other well known materials. The drive member 10 includes a plurality of lugs 12, only one of which is shown, that protrude above the surface 14 of the drive member, and are used in general terrain for traction and propelling a snowmobile, an all terrain vehicle, off road motorcycles and self-propelled power equipment (not shown). The lugs 12 have an upper surface 16 that is generally flat, and has some width represented at the double arrows 18 that is sufficient to provide a surface for mounting one or more screw-in studs 20 made according to the present invention.

One screw-in stud 20 is shown installed in the lug 12 in FIG. 1, and is shown in more detail in FIGS. 3 and 4. The screw-in stud 20 has a threaded shank 22 that has a self-tapping thread 24 coming from a sharp end point 26 so that it will self-tap into the lug 12. The shank 22 has a head 28 on the end and a support washer 30 is formed around the head. The head 28 is a hex head that can be used for driving the screw-in with a socket, generally using a powered socket wrench. The head 28 has an integral cone shaped, penetrating tip 32 protruding therefrom, a selected distance, for example, in the range of ¼″, from the top of the head 28 to the outer tip shown at 34.

The outer tip 34 is sharpened, as shown, and in the preferred form, the outer tip 34 is formed on a carbide or other hardened material pin 36 that is integral with the steel cone shaped tip 32 as shown at FIG. 4. This carbide pin 36 is embedded in the metal cone 32, and has a protruding end that forms the very tip 34 that is sharpened. Tip 34 is a penetrating tip that will pierce hard surfaces such as ice and the like and provide greater traction.

In use, each of the lugs 12 from a drive member, compressing a tire or track 10 can be provided with one or more of the screw-in studs (usually at least two screws per lug), merely by self-tapping them in using a power driver. The screw-in stud threads in until the washer 30 engages the upper surface 16 of the lug 12, and then the parts can tightened down so that they will not come loose. In this manner, the self-tapping screw stud 20 insures security, and provides for an easily replaceable, and highly effective stud end or cone 32 for penetrating ice or hard ground and providing traction.

The screws can be made of steel, and the cone end 32 can be made of a hardened steel, if desired. The carbide pin 36 can then be omitted. Also, different types of threads can be used, so long as they will securely hold the screw-in stud securely in position during use.

The screw in stud is used in combination with lugs of various types, for tires on ATV's, motorcycles, and on self-propelled power equipment such as snow blowers or wheel loaders, as well as on drive belts for snowmobiles. The studs are useful wherever added traction on hard surfaces is needed.

Although the present invention has been described with reference to preferred embodiments, workers skilled in the art will recognize that changes may be made in form and detail without departing from the spirit and scope of the invention.

What is claimed is:

1. A screw-in stud for a drive track having a lug, said screw-in stud having a shank, a thread on such shank that is threadable into the lug, a head portion, said head portion having a sharpened protrusion on an outer end thereof ending in a penetrating point.

2. The screw in stud of claim 1, wherein said penetrating point comprises a sharpened carbide pin embedded in the protrusion.

3. The screw in stud of claim 2, wherein said protrusion is generally cone shaped, and is integral with the head of the screw.

4. The screw in stud of claim 1, wherein the head portion has a section drivable with a wrench.

5. A combination of a drive member for a vehicle having a ground engaging lug with an outer surface and a screw in stud having a threaded shank threaded into the lug and having a head on the outside of the outer surface of the lug, and a sharpened projection extending outwardly from the head.

6. The combination of claim 5, wherein the sharpened projection is conical and a carbide steel insert forming an outer end of the projection.
